(19) United States
(12) Patent Application Publication
(10) Pub. No.: US 2008/0194733 A1
(43) Pub. Date: Aug. 14, 2008

(54) Pigmented Inks Suitable For Use With Ceramics and Method of Producing Same

(75) Inventors: Warren Green, Herzliya (IL); Hagai Peled, Tel Aviv (IL); Haim Gorodesky, Rechovot (IL)

Correspondence Address: SIMON KAHN - PYI Tech, Ltd.;c/o LANDONIP, INC, 1700 DIAGONAL ROAD, SUITE 450, ALEXANDRIA, VA, 22314-2866, US

(73) Assignee: JETTABLE, LTD., Netanya (IL)

(21) Appl. No.: 11/915,175

(22) PCT Filed: May 21, 2006
(86) PCT No.: PCT/IL2006/000599

§ 371 Date: Nov. 21, 2007

Related U.S. Application Data
(60) Provisional application No. 60/594,977, filed on May 24, 2005.

(51) Int. Cl. C09D 11/02

(52) U.S. Cl. 523/160

(57) ABSTRACT

A method for producing an ink suitable for use with inkjet printing for decorating a ceramic comprising; providing a pigment stabile at ceramic production temperatures; providing a dispersant; providing a medium selected from one of glycol ether esters exhibiting a boiling point in excess of 200° C. and long chain aliphatic solvents, the medium exhibiting a surface tension suitable for use with inkjet printing equipment; mixing 40-60% by weight of the provided pigment into the provided medium together with 0.4% w/w pigment of the provided dispersant to form a mixture, such that viscosity of the mixture exceeds 50 cps; milling the mixture while maintaining viscosity between 50 cps and 800 cps, until average particle size is 1 micron; adding the medium to the milled mixture under shear until viscosity reaches 15 cps; and filtering the unfiltered ink through 3 micron and 1 micron depth cartridges.

### CROSS-REFERENCE TO RELATED APPLICATION

This application claims priority from U.S. Provisional Patent Application Ser. No. 60/594,977 filed May 24, 2005 entitled “Method for Decoration of Ceramic Bodies, A System Employing It and Tiles Decorated Thereby” the entire contents of which are incorporated herein by reference.

### BACKGROUND OF THE INVENTION

The invention relates generally to the field of ceramic tile production and in particular to pigmented inks and their method of manufacture suitable for use with drop-on-demand inkjet printing on ceramic tiles.

The ceramic tile industry produces close to 7 billion square meters of tile a year, with production occurring in over 100 countries. A key factor in customer acceptance of a ceramic tile is the quality of its decoration. Thus, decoration is a crucial element in the tile manufacturing process, however existing mass production techniques limit the scope and quality of available decorations. Additionally, existing techniques limit the flexibility of, and ease of, new design set-up and changeover between designs.

The process of ceramic tile production involves the steps of shaping a mixture of inorganic minerals, such as clay, glazing with a coating of ground glass and other minerals, decoration and subsequent heating, also known as firing, the raw formed tile material in a furnace, also known as a kiln. The raw formed tile material may also be pre-fired as a biscuit, glazed, decorated and then fired again. Kiln temperatures on the order of 500° C. to 1800° C. are commonly utilized. Thus, any ink or decorating substance used must be compatible with the high temperatures associated with firing the tile.

Various methods of decorating tile are known in the industry, however a key criteria is the ability to use the method of decorating in mass production, including production lines achieving an output of up to 5,000 m² of tile per day. Preferably, the method of decorating should be suitable for use with tiles of all shapes, sizes and thicknesses, including tiles with uneven surfaces, known as structured body tiles, such as imitation natural stone products. The method of decorating should preferably allow for both strong and weak color density on the same tile, and preferably also allow for ease of changeover between designs. Most importantly, it should allow for short runs, allowing the manufacturer to respond quickly to orders and reduce stock holdings. Ideally, the method should allow for decorating using the wide gamut of colors available from mixing four basic colors, as is common in the printing industry. Unfortunately, the organic pigment inks commonly used in the printing industry are incompatible with the high kiln temperatures.

One method of printing decoration on tile, which allows for printing using four basic colors, is rotary flexo printing. Unfortunately, rotary flexo printing is only suitable for high volume tile production utilizing long runs. Furthermore, any method of contact printing, including rotary flexo printing, requires flat surfaces and a large setup time when introducing a new design. A technician must prepare the ink, stop the production line, change the engraved sleeves of the printer rollers, and then adjust the registration and pressure to achieve the desired results. Such a process is time consuming, and costly. Furthermore, the use of contact printing leads to less than optimum results with structured body tiles, which do not present a uniform flat surface for the printing rollers. Typically the rollers only contact the peaks, or raised portions, of the uneven surface and do not succeed in properly decorating the depressed portion. Additionally, contact rollers achieve color intensity by a combination of engraved depth on the roller sleeve and controlled pressure, which limits the range of color intensity available. However, the largest drawback is that the engraved silicone rollers typically employed have a cost approaching [symbol] 1,000, meaning that a four color tile run costs [symbol] 4,000 before the first tile is printed.

Another method of printing decoration on tile, which allows for printing using four basic colors, and is suitable for high volume mass production, is inkjet printing, and in particular drop on demand (DOD) inkjet printing. DOD inkjet printing is well known in the printing industry, but has not been widely adopted in the ceramics industry due to the lack of inks suitable for both high temperatures and use with standard DOD inkjet equipment. In particular, such inks should preferably: be available in a plurality of stable colors which are capable for used with process printing, i.e. be capable of undergoing mixing and forming additional colors; display little or no settling or agglomeration upon prolonged storage; be easily redispersed; not form hard pack sediments for at least 6 months after delivery; and maintain a steady viscosity over the printing process, the viscosity being 8-20 centipoises (cps) which is suitable for use with standard DOD inkjet equipment.

U.S. Pat. No. 6,357,868 to Pfaff et al, whose entire contents are incorporated herein by reference, discloses a method of decorating ceramics by means of inkjet technology. A color paste containing at least 30 wt. % inorganic solids, such as pigments and glass frits, and a thermoplastic medium having a melting point of at least 30° C. is applied to the surface to be decorated by means of a heatable inkjet printhead. The requirement for a heatable inkjet printhead increases the cost of the unit. Furthermore, the ink is not easily adapted to flow from a storage container to a printhead, and is thus restricted to use with specially designed equipment. The technique disclosed uses a mechanical inkjet with a high cost per nozzle rather than a piezo inkjet with its associated low cost per nozzle, meaning that it is slow, expensive and unsuitable for mass production. Additionally, the method exhibits a low resolution resulting in a limited color gamut.

U.S. Pat. No. 6,402,823 to Garcia Sainz et al., the entire contents of which is incorporated herein by reference, discloses individual inks and an ink set for use in generating intermediate colors via the combination of separate inks applied by an inkjet printer to the glazed surface of an article, such as glazed ceramic architectural tile. The ink set comprises inks containing soluble transition metal complexes which adds to the cost, and certain inks are considered dangerous. Such metal complexes produce only a limited color gamut and require special components in the tile glazes in order to generate color, rendering them relatively expensive and inconvenient for the tile manufacturer.

International Publication WO 2005/019360 of International Patent Application PCT/IL2004/000771 to Magdassi et al. discloses ink for printing on ceramic glass surfaces such as glass, which contains glass frits for silica nanoparticles and optionally a pigment, and is suitable for ink jet printing. The requirement for sub-micron particles of binding composition adds to the cost. Additionally, no disclosure is made as to how to produce colored inks or generate process color.

There is thus a long felt need for an improved ink for ceramic decoration.

### SUMMARY OF THE INVENTION

Accordingly, it is a principal object of the present invention to overcome the disadvantages of prior art decorating ceramics. This is provided in the present invention by a method for producing an ink suitable for the high temperatures of ceramic production, and further suitable for use with drop-on-demand inkjet printing equipment. The pigments employed are preferably drawn from those well known to the tile decorators, allowing them to use their existing glaze formulations and manufacturing procedures. In particular a pigment, dispersant and a medium are provided, the medium exhibiting the appropriate surface tension and wetting for a nozzle plate of inkjet printing equipment, including equipment employing up to 20,000 nozzles. The pigment is milled while maintaining viscosity between 50-800 cps, preferably between 500-800 cps, and further preferably about 800 cps, until average particle size is about 1 micron. Optionally, a frit dispersion is added to promote better fusion of the pigment to the tile glaze during kiln filing. Additional medium is then added to lower the viscosity to about 8-20 cps and preferably 10-12 cps.

The method of controlling viscosity by titration as required until an endpoint has been achieved helps overcome batch to batch variations in the inorganic pigments used. The use of titration advantageously leads to the use of a minimum amount of dispersant being utilized, stable viscosity and good redispersability.

The resultant ink does not clog or otherwise disturb drop-on-demand inkjet printing equipment, and does not settle within the ink circuit and form a sticky deposit that can not be disturbed, also known as hard pack. In the event of any phase separation within the ink, minimal shear force, such as by shaking, will cause a return to a uniform phase. The minimal shear force can be brought about by stirring and constant recirculation.

Furthermore, the solvents employed meet safety requirements in the major industrial countries without requiring special ventilation.

The invention provides for a method for producing an ink suitable for use with drop-on-demand inkjet printing for decorating a ceramic which will be heated to at least 500° C., the method comprising: providing a pigment selected for stability at ceramic production temperatures; providing a dispersant selected from one of salts of block copolymers with acidic groups and a high molecular weight dispersant; providing a medium selected from one of glycol ether esters exhibiting a boiling point in excess of 200° C. and long chain aliphatic solvents, the medium exhibiting a surface tension suitable for use with drop-on-demand inkjet printing equipment and further exhibiting appropriate wetting of a nozzle plate of the drop-on-demand inkjet printing equipment; mixing about 40-60% by weight of the provided pigment into the provided medium together with about 0.4% w/w pigment of the provided dispersant to form a mixture, such that viscosity of the mixture exceeds 50 cps defined at room temperature; milling the mixture while maintaining viscosity between 50 cps and about 800 cps defined at room temperature, until average particle size is about 1 micron; adding the medium to the milled mixture under shear until viscosity reaches about 8-20 cps defined at room temperature, to produce an unfiltered ink; and filtering the unfiltered ink through 3 micron and 1 micron depth cartridges.

In one embodiment the mixing is performed such that viscosity of the mixture exceeds 500 cps defined at room temperature. In another embodiment the maintaining of the milling comprises: in the event viscosity increases above about 800 cps at room temperature, adding 0.2% of the provided dispersant. In one further embodiment at least one of the viscosity and the average particle size is checked periodically during the milling.

In one embodiment the milling is by a bead mill containing media in size range of about 0.5 mm. In one further embodiment the milling is at rotation of about 2000-4000 rpm.

In one embodiment the provided pigment is in particulate form. In another embodiment the provided pigment is in particulate form with particle size of about 10 microns.

In one embodiment the provided pigment is selected from one of ZrPr; ZrVaSi; FeCrCoNi; CrCaSnSi: CoSi; and FeCrZn. In another embodiment the filtering is through cartridges exhibiting polypropylene media.

In one embodiment the mixing is done at least partially under high shear conditions. In another embodiment the viscosity during the milling is maintained between about 500 cps and about 800 cps defined at room temperature.

In one embodiment the milling is further until the diameter of the 90^{th} percentile is below 1.5 microns. In another embodiment the adding of the medium to the milled mixture is until viscosity reaches about 10-12 cps.

In another embodiment the method further comprises adding frit dispersion before the filtering. In one further embodiment the frit dispersion is produced by the method of: providing a frit in particulate form; providing a dispersant selected from one of salts of block copolymers with acidic groups and a high molecular weight dispersant, the dispersant being compatible with the dispersant of the ink; providing a medium selected from one of glycol ether esters exhibiting a boiling point in excess of 200° C. and long chain aliphatic solvents, the medium exhibiting a surface tension suitable for use with drop-on-demand inkjet printing equipment and further exhibiting appropriate wetting of a nozzle plate of the drop-on-demand inkjet printing equipment, the medium being compatible with the medium of the ink; mixing about 40-60% by weight of the provided frit into the provided medium together with about 0.4% w/w frit of the provided dispersant to form a frit mixture, such that viscosity of the frit mixture exceeds 50 cps defined at room temperature; milling the frit mixture while maintaining viscosity between 50 cps and about 800 cps defined at room temperature, until average particle size is about 1 micron; and adding the medium to the milled frit mixture under shear until viscosity reaches about 8-20 cps defined at room temperature.

The invention independently provides for an ink suitable for use with drop-on-demand inkjet printing for decorating a ceramic which will be heated to at least 500° C., the ink being produced according to the following process: providing a pigment selected for stability at ceramic production temperatures; providing a dispersant selected from one of salts of block copolymers with acidic groups and a high molecular weight dispersant; providing a medium selected from one of glycol ether esters exhibiting a boiling point in excess of 200° C. and long chain aliphatic solvents, the medium exhibiting a surface tension suitable for use with drop-on-demand inkjet printing equipment and further exhibiting appropriate wetting of a nozzle plate of the drop-on-demand inkjet printing equipment; mixing about 40-60% by weight of the provided pigment into the provided medium together with about 0.4% w/w pigment of the provided dispersant to form a mixture, such that viscosity of the mixture exceeds 50 cps at room temperature; milling the mixture while maintaining viscosity between 50 cps and about 800 cps, the cps being determined at room temperature, until average particle size is about 1 micron; adding the medium to the milled mixture under shear until viscosity reaches about 8-20 cps at room temperature to produce an unfiltered ink; and filtering the unfiltered ink through 3 micron and 1 micron depth cartridges.

The invention independently provides for a pigmented ink suitable for use with inkjet drop on demand printing for ceramics, the pigmented ink comprising: finely ground pigments exhibiting a D50 particle size of about 1 micron, the pigments exhibiting stability at ceramic production temperatures; a medium exhibiting a surface tension suitable for use with drop-on-demand inkjet printing equipment, and exhibiting good wetting for a nozzle plate of an inkjet printing equipment; and a dispersant, wherein the pigmented ink exhibits a viscosity of 8-20 cps, any settling or agglomeration can be dispersed by shaking and no hard pack is formed.

In one embodiment the viscosity is 10-12 cps. In another embodiment the medium is selected from one of the family of glycol ether esters exhibiting a boiling point in excess of 200° C. and the family of long chain aliphatic solvents.

In one embodiment the dispersant is an organic dispersant. In another embodiment the dispersant comprises one of salts of block copolymers with acidic groups and a high molecular weight dispersant.

In one embodiment the finely ground pigments comprise one of ZrPr; ZrVaSi; FeCrCoNi; CrCaSnSi: CoSi; and FeCrZn. In another embodiment the shaking comprises up to 3 minutes on a horizontal shaker at up to 100 rpm.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawing:

FIG. 1 illustrates a high level flow chart of an embodiment of the method of production of ink in accordance with the principle of the current invention.

### DETAILED DESCRIPTION OF THE PREFERRED EMBODIMENTS

The present embodiments enable a large set of pigmented color inks based on finely ground ceramic pigments which are stable, mixable for drop-on-demand inkjet process printing and display little settling or agglomeration upon prolonged storage. Any settling can be dispersed by shaking and no hard pack is formed. The inks have a good shelf life and maintain a steady viscosity remaining in the range of 8-20 cps, and preferably 10-12 cps, and can be formulated to provide strong colors.

This is provided in the present invention by a method for producing an ink suitable for the high temperatures of ceramic production, and further suitable for use with drop-on-demand inkjet printing equipment. In particular a pigment, dispersant and a medium are provided, the medium exhibiting the appropriate surface tension and wetting for a nozzle plate of the inkjet printing equipment. The pigment is milled while maintaining viscosity between 50-800 cps, preferably 500-800 cps, and further preferably about 800 cps, until average particle size is about 1 micron. Optionally, a frit dispersion is added to promote better fusion of the pigment to the tile glaze during kiln firing. Additional medium is then added to lower the viscosity to about 8-20 cps and preferably 10-12 cps.

The method of controlling viscosity by titration as required until an endpoint has been achieved helps overcome batch to batch variations in the inorganic pigments used. The use of titration advantageously leads to the use of a minimum amount of dispersant being utilized, stable viscosity and good redispersability.

The resultant ink does not clog or otherwise disturb drop-on-demand inkjet printing equipment, and does not settle within the ink circuit and form a sticky deposit that can not be disturbed, also known as hard pack. In the event of any phase separation within the ink, minimal shear force, such as by shaking, will cause a return to a uniform phase. The minimal shear force can be brought about by stirring and constant recirculation.

The term hard pack as used in this document refers to a sediment which adheres to the wall or floor of a container. The term shaking as used in this document refers to a force no greater than which can be applied by up to 3 minutes on a horizontal shaker at no more than 100 rpm. Typically, 2-3 vigorous manual shakes are sufficient.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

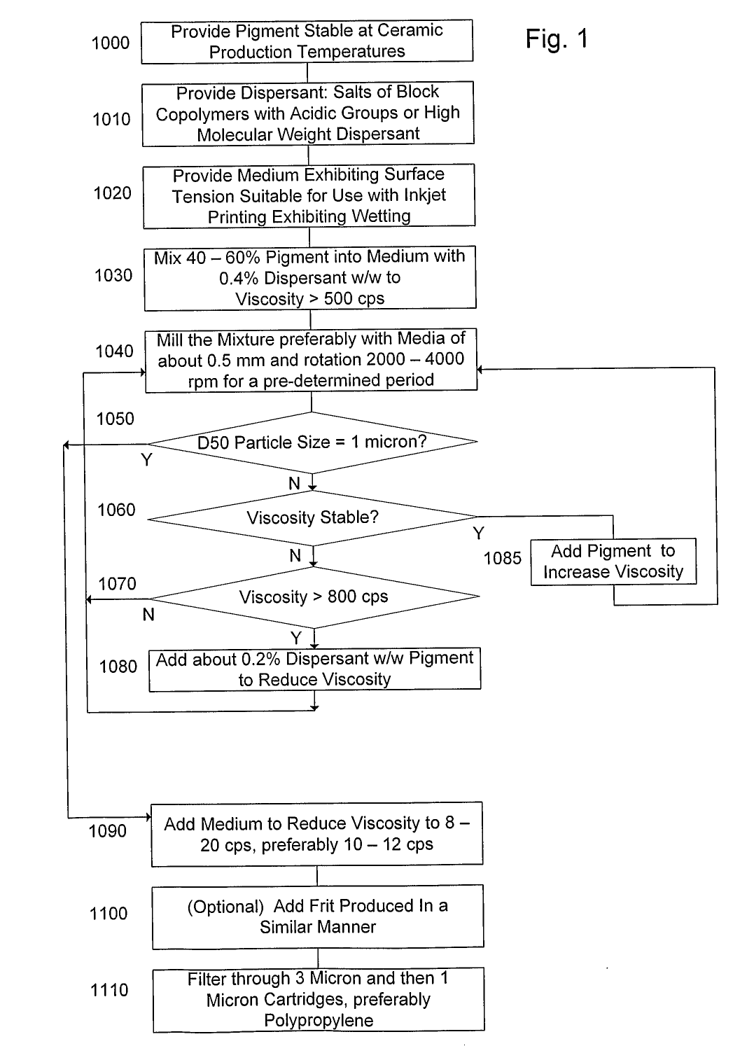

FIG. 1 illustrates a high level flow chart of an embodiment of the method of production of ink in accordance with the principle of the current invention. In stage 1000 a pigment stable at ceramic production temperatures is provides. Preferably the pigment is inorganic, and is preferably provided in particulate form, usually with particle size of about 10 microns. In an exemplary embodiment the pigment is one of a yellow pigment of ZrPr; a turquoise blue pigment of ZrVaSi; a black pigment of FeCrCoNi; a coral pigment of CrCaSnSi; a cobalt blue pigment of CoSi and a brown pigment of FeCrZn. The above is not meant to be limiting in any way and other pigment suitable for use at ceramic production temperatures are specifically included.

It is to be noted that the above list does not contain the standard subtractive complementary cyan, magenta, yellow and black colors well know in the graphic arts, it contains instead those inorganic pigments suitable for ceramic tiles which approach the characteristics of the CMYK model. This is not meant to be limiting in any way, and a set of pigments producing said colors is within the scope of the invention. A different set of inks, other than the standard subtractive set, such as those described above, supplies a large range of colors. An important factor in the ultimate look of the tile and its decoration is the depth of color. Some limitation on the range of colors available on a specific tile may be offset by deeper colors in somewhat limited range. Thus, the designer of the decoration is offered a set of inks compatible with the desired end result.

In stage 1010 a dispersant, preferably an organic dispersant, further preferably selected from either salts of block copolymers with acidic groups or a high molecular weight dispersant is provided. Suitable dispersants are available from a number of suppliers including Degussa of Dusseldorf, Germany; Byk-Chemie of Wesel, Germany; and Avecia of Manchester, U.K.

In stage 1020 a medium providing a surface tension suitable for use with drop-on-demand inkjet printing equipment, and exhibiting good wetting for a nozzle plate of the inkjet printing equipment is provided. The medium preferably is selected from the family of glycol ether esters exhibiting a boiling point in excess of 200° C. or from the family of long chain aliphatic solvents. In an exemplary embodiment butyl glycol ether acetate is used.

In stage 1030 approximately 40-60% pigment, as described above in relation to stage 1000 is mixed into the medium provided in stage 1020 together with approximately 0.4% weight by weight (w/w) pigment as described above in relation to stage 1010, preferably under high shear conditions. The precise amount of dispersant is selected such that viscosity, as defined at room temperature of 25° C., is greater than 50 cps, and preferably greater than 500 cps. Further preferably, viscosity is 500-800 cps, with the lower end of the range selected at this stage. The viscosity is recorded.

For the purposes of clarity, all viscosity measurements are defined herein at 25° C., which is alternatively denoted room temperature. This is not meant to be limiting in any way, and the method can be performed at other temperatures without exceeding the scope of the invention.

In stage 1040 the mixture as described in relation to stage 1040 is milled. As will be described further hereinto below, the mixture is milled while observing viscosity between 50-800 cps, preferably 500-800 cps, and until average particle size is approximately 1 micron. Preferably, the milling is accomplished in a bead mill containing media in size range of about 0.5 mm. Preferably the mill is rotating at a speed of 2000-4000 rpm with a basket screen exhibiting a 0.26 mm opening. In one embodiment the mill is similar to those supplied by Netzsch, Draiswerke, Premier or others. Stage 1040 is continued for a pre-determined period, preferably for about 30 minutes.

In stage 1050, the milling of stage 1040 is temporarily suspended, and the particle size is measured. In the event that the average particle size, also known as the diameter of the 50% percentile size, or the D50, is not about 1 micron, and preferably further the D90 is not less than 1.5 microns, stage 1060 as described below is performed. In an exemplary embodiment particle size was measured with a Malvern Mastersizer available from Malvern Instruments Limited of Worcestershire, U.K.

In stage 1060 viscosity is checked, recorded and compared with the immediately previously recorded viscosity of either stage 1030 or an earlier incidence of stage 1060 to determine if viscosity is stable. It is to be understood that at least two viscosity readings, preferably at pre-determined intervals, further preferably at pre-determined 30 minute intervals, are required in order to determine that viscosity is stable. A stable viscosity is defined herein as a viscosity which does not change by more than 10% between two subsequent readings, and preferably not more than 5%. Preferably, viscosity is determined by a cone and plate rotational viscometer, available from Brookfield Engineering Laboratories, Inc. of Middleboro, Mass., but in practice a spindle viscometer with a Brookfield UL adapter is also satisfactory.

In the event that viscosity is not stable, i.e. it has increased indicating that milling is successfully proceeding; in stage 1070 the viscosity recorded in stage 1060 is compared with 800 cps. In the event that viscosity has risen to be above 800 cps, in stage 1080 viscosity is reduced towards a target of 500 cps by adding about 0.2% dispersant w/w pigment and then stage 1040 as described above is again performed.

In the event that in stage 1070 viscosity has not risen to be above 800 cps, stage 1040 as described above is again performed.

In the event that in stage 1060 viscosity has not risen from the previous recorded viscosity, i.e. viscosity is stable indicative that successful milling is not proceeding; in stage 1085 additional pigment is added to increase viscosity while remaining significantly below the maximum of 800 cps, and stage 1040 as described above is again performed.

In the event that in stage 1050, the D50 particle size is about 1 micron, and preferably the D90 is less than 1.5 microns, in stage 1090 additional medium as described above in relation to stage 1020 is added to reduce viscosity to about 8-20 cps, and preferably to about 10-12 cps. Preferably the medium is added under shear.

In optional stage 1100 frit, produced as described above in relation to stages 1010-1090, utilizing a compatible, and preferably identical, medium and dispersant is added as desired. The use of frit aids in fusion to the ceramic tile body. In an exemplary embodiment 80 grams of frit dispersion is added to an unfiltered ink prepared as described above comprising 1 liter of butyl glycol ester acetate, 1 kg of brown spinel pigment (FeCrZn) and 5 grams of dispersant such as a dispersant from one of Degussa, Byk and Avecia.

In stage 1110, the mixture as described above in relation to stage 1090 and optional stage 1100 is filtered through a 3 micron cartridge filter and then a 1 micron cartridge filter. Preferably, the cartridge filter comprises a polypropylene media.

The resulting ink is stored in glass or HDPE bottles, although a Teflon container may be used. The resulting ink is compatible with drop-on-demand inkjet printheads such as those produced by Spectra Inc. (USA) or Hitachi Dataproducts (USA). In an exemplary embodiment, the printing system is modified to allow for recirculation of the ink through the printhead and back to the ink holding tank, in order to prevent settling.

Samples of ink produced according to the above method were printed using a flat bed inkjet printer, where the printheads are aligned vertically over a horizontal carrier on which the tile body is placed. The motion system and printheads were computer controlled. A graphic image resembling natural stone was loaded into the computer and processed for color separation using the available color profiles of the supplied ink and dot screen patterns of the printing equipment. The resultant images were printed on a tile body. The tile body, optionally coated with glaze, was placed in a kiln and fired at appropriate temperatures of 850° C. to 1250° C. The resulting tile exhibited attractive decoration resistant to both chemical attack and abrasion.

Thus the present embodiments enable a set of pigmented inks based on finely ground ceramic pigments that are stable, mixable for drop-on-demand inkjet process printing and display little settling or agglomeration upon prolonged storage. Any settling can be dispersed by shaking and no hard pack is formed. The inks maintain a steady viscosity remaining in the range of 8-20 cps, and preferably 10-12 cps, and can be formulated to provide strong colors.

The inks are prepared by providing a pigment, a dispersant and a medium, the medium exhibiting the appropriate surface tension and wetting for a nozzle plate of the inkjet printing equipment. The pigment is milled while maintaining viscosity between 50-800 cps, preferably 500-800 cps and further preferably about 800 cps, until average particle size is about 1 micron. Optionally, a frit dispersion is added to promote better fusion of the pigment to the tile glaze during kiln firing. Additional medium is then added to lower the viscosity to about 8-20 cps and preferably 10-12 cps.

The method of controlling viscosity by titration as required until an endpoint has been achieved helps overcome batch to batch variations in the inorganic pigments used. The use of titration advantageously leads to the use of a minimum amount of dispersant being utilized, stable viscosity and good redispersability.

The resultant ink does not clog or otherwise disturb drop-on-demand inkjet printing equipment, and does not settle within the ink circuit and form a sticky deposit that can not be disturbed, also known as hard pack. In the event of any phase separation within the ink, minimal shear force, such as by shaking, will cause a return to a uniform phase. The minimal shear force can be brought about by stirring and constant recirculation.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

We claim:

1. A method for producing an ink suitable for use with drop-on-demand inkjet printing for decorating a ceramic which will be heated to at least 500° C., the method comprising:
providing a pigment selected for stability at ceramic production temperatures;
providing a dispersant selected from one of salts of block copolymers with acidic groups and a high molecular weight dispersant;
providing a medium selected from one of glycol ether esters exhibiting a boiling point in excess of 200° C. and long chain aliphatic solvents, said medium exhibiting a surface tension suitable for use with drop-on-demand inkjet printing equipment and further exhibiting appropriate wetting of a nozzle plate of the drop-on-demand inkjet printing equipment;
mixing about 40-60% by weight of said provided pigment into said provided medium together with about 0.4% w/w pigment of said provided dispersant to form a mixture, such that viscosity of said mixture exceeds 50 cps defined at room temperature;
milling said mixture while maintaining viscosity between 50 cps and about 800 cps, defined at room temperature, by adding said provided dispersant in the event viscosity increases above about 800 cps, until average particle size is about 1 micron;
adding said medium to said milled mixture under shear until viscosity reaches about 8-20 cps defined at room temperature, to produce an unfiltered ink; and
filtering said unfiltered ink through 3 micron and 1 micron depth cartridges.

2. A method according to claim 1, wherein said mixing is performed such that viscosity of said mixture exceeds 500 cps defined at room temperature.

3. A method according to claim 1, wherein said adding said provided dispersant comprises:
adding about 0.2% of said provided dispersant.

4. A method according to claim 1, wherein at least one of said viscosity and said average particle size is checked periodically during said milling.

5. A method according to claim 1, wherein said milling is by a bead mill containing media in size range of about 0.5 mm.

6. A method according to claim 5, wherein said milling is at rotation of about 2000-4000 rpm.

7. A method according to claim 1, wherein said provided pigment is in particulate form.

8. A method according to claim 1, wherein said provided pigment is in particulate form with particle size of about 10 microns.

9. A method according to claim 1, wherein said provided pigment is selected from one of ZrPr; ZrVaSi; FeCrCoNi; CrCaSnSi: CoSi; and FeCrZn.

10. A method according to claim 1, wherein said filtering is through cartridges exhibiting polypropylene media.

11. A method according to claim 1, wherein said mixing is done at least partially under high shear conditions.

12. A method according to claim 1, wherein said viscosity during said milling is maintained between about 500 cps and about 800 cps defined at room temperature.

13. A method according to claim 1, wherein said milling is further until the diameter of the 90^{th} percentile is below 1.5 microns.

14. A method according to claim 1, wherein said adding said medium to said milled mixture is until viscosity reaches about 10-12 cps.

15. A method according to claim 1, further comprising adding frit dispersion before said filtering.

16. A method according to claim 15, wherein said frit dispersion is produced by the method of:
providing a frit in particulate form;
providing a dispersant selected from one of salts of block copolymers with acidic groups and a high molecular weight dispersant, said dispersant being compatible with said dispersant of said ink;
providing a medium selected from one of glycol ether esters exhibiting a boiling point in excess of 200° C. and long chain aliphatic solvents, said medium exhibiting a surface tension suitable for use with drop-on-demand inkjet printing equipment and further exhibiting appropriate wetting of a nozzle plate of the drop-on-demand inkjet printing equipment, said medium being compatible with said medium of said ink;
mixing about 40-60% by weight of said provided frit into said provided medium together with about 0.4% w/w frit of said provided dispersant to form a frit mixture, such that viscosity of said frit mixture exceeds 50 cps defined at room temperature;
milling said frit mixture while maintaining viscosity between 50 cps and about 800 cps, defined at room temperature, by adding said provided dispersant in the event viscosity increases above about 800 cps, until average particle size is about 1 micron; and
adding said medium to said milled frit mixture under shear until viscosity reaches about 8-20 cps defined at room temperature.

17. An ink suitable for use with drop-on-demand inkjet printing for decorating a ceramic which will be heated to at least 500° C., the ink being produced according to the following process:
providing a pigment selected for stability at ceramic production temperatures;
providing a dispersant selected from one of salts of block copolymers with acidic groups and a high molecular weight dispersant;
providing a medium selected from one of glycol ether esters exhibiting a boiling point in excess of 200° C. and long chain aliphatic solvents, said medium exhibiting a surface tension suitable for use with drop-on-demand inkjet printing equipment and further exhibiting appropriate wetting of a nozzle plate of the drop-on-demand inkjet printing equipment;
mixing about 40-60% by weight of said provided pigment into said provided medium together with about 0.4% w/w pigment of said provided dispersant to form a mixture, such that viscosity of said mixture exceeds 50 cps at room temperature;
milling said mixture while maintaining viscosity between 50 cps and about 800 cps, said cps being determined at room temperature, by adding said provided dispersant in the event viscosity increases above about 800 cps, until average particle size is about 1 micron;
adding said medium to said milled mixture under shear until viscosity reaches about 8-20 cps at room temperature to produce an unfiltered ink; and
filtering said unfiltered ink through 3 micron and 1 micron depth cartridges.

18. A pigmented ink suitable for use with inkjet drop on demand printing for ceramics, the pigmented ink comprising:
finely ground pigments exhibiting a D50 particle size of about 1 micron, the pigments exhibiting stability at ceramic production temperatures;
a medium exhibiting a surface tension suitable for use with drop-on-demand inkjet printing equipment, and exhibiting good wetting for a nozzle plate of an inkjet printing equipment; and
a dispersant,
wherein the pigmented ink exhibits a viscosity of 8-20 cps, any settling or agglomeration can be dispersed by shaking and no hard pack is formed.

19. A pigmented ink in accordance with claim 18, wherein said viscosity is 10-12 cps.

20. A pigmented ink in accordance with claim 18, wherein said medium is selected from one of the family of glycol ether esters exhibiting a boiling point in excess of 200° C. and the family of long chain aliphatic solvents.

21. A pigment ink in accordance with claim 18, wherein said dispersant is an organic dispersant.

22. A pigmented ink in accordance with claim 18, wherein said dispersant comprises one of salts of block copolymers with acidic groups and a high molecular weight dispersant.

23. A pigmented ink in accordance with claim 18, wherein said finely ground pigments comprise one of ZrPr; ZrVaSi; FeCrCoNi; CrCaSnSi: CoSi; and FeCrZn.

24. A pigmented ink in accordance with claim 18, wherein said shaking comprises up to 3 minutes on a horizontal shaker at up to 100 rpm.
